(19) United States
(12) Patent Application Publication
(10) Pub. No.: US 2014/0013118 A1
(43) Pub. Date: Jan. 9, 2014

(54) INFORMATION PROCESSING APPARATUS, TERMINAL DEVICE, INFORMATION PROCESSING SYSTEM, METHOD FOR INFORMATION PROCESSING, AND STORAGE MEDIUM

(71) Applicant: FeliCa Networks, Inc., Tokyo (JP)

(72) Inventor: Tsutomu Kumai, Tokyo (JP)

(21) Appl. No.: 13/922,562

(22) Filed: Jun. 20, 2013

(30) Foreign Application Priority Data
Jul. 3, 2012 (JP) 2012-149166

(51) Int. Cl. H04L 9/32

(52) U.S. Cl. CPC H04L 9/3268
USPC 713/175

(57) ABSTRACT

There is provided an information processing apparatus, including a data generation section generating a specified data stream, and also generating a plurality of segment data sets by segmenting the generated specified data stream and by adding authentication data to each of the segmented data streams, and a data transmission section transmitting the plurality of segment data sets generated by the data generation section to respective apparatuses.

### BACKGROUND

The present disclosure relates to an information processing apparatus, a terminal device, an information processing system, a method for information processing, and a storage medium.

In recent years, a system is widely spreading which uses a technology of proximity non-contact communication with use of a card (IC card) that incorporates an IC chip for use in automatic ticket gates of stations, and settlement of commodity bills in stores by electronic money, or the like. In such a system, placing an IC card over a reader writer enables use of automatic ticket gates of stations, and settlement of commodity bills in stores by electronic money, or the like. Further, a system is also widely spreading which involves placing of a mobile phone, which incorporates the IC chip, over a reader writer to enable similar use of automatic ticket gates of stations and settlement of commodity bills, or the like.

### SUMMARY

Recently, a mobile phone which does not incorporate an IC chip is also widely spreading. As the mobile phone which does not incorporate an IC chip spreads, it is expected to develop a technology which enables such a mobile phone to implement the above-stated settlement processing by electronic money and the like as conveniently as in the processing by the aforementioned proximity non-contact communication.

For example, Japanese Patent Laid-Open No. 2007-312128 discloses a technology which may enhance the safety of electronic data. Disclosed in Japanese Patent Laid-Open No. 2007-312128 is a technology for achieving enhancement in the safety of electronic data by dispersing confidential information. According to the technology of Japanese Patent Laid-Open No. 2007-312128, the confidentiality of information can be kept. However, in the settlement processing of commodity bills by electronic money, it is expected not only to keep the confidentiality of information but also to have resistance against tampering or reuse of information after the information is used.

Accordingly, in the present disclosure, it is desirable to provide new and modified information processing apparatus, terminal device, information processing system, method for information processing, and storage medium for executing information transfer while keeping confidentiality and having resistance against tampering and reuse of the information.

According to one embodiment of the present disclosure, there is provided an information processing apparatus, including a data generation section generating a specified data stream, and also generating a plurality of segment data sets by segmenting the generated specified data stream and by adding authentication data to each of the segmented data streams, and a data transmission section transmitting the plurality of segment data sets generated by the data generation section to respective apparatuses.

According to one embodiment of the present disclosure, there is provided a terminal device, including a data acquisition section acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and a data coupling section coupling the first data with the second data on condition that validity of the first authentication data and the second authentication data has been confirmed.

According to one embodiment of the present disclosure, there is provided an information processing system, including a terminal device, and a mobile terminal. The mobile terminal may include a data acquisition section acquiring second data which has been generated in a server apparatus and to which second authentication data has been added, and the terminal device may include a data acquisition section acquiring first data which has been generated in the server apparatus and to which first authentication data has been added, and also acquiring second data which has been generated in the server apparatus, which has been transmitted from the server apparatus to the mobile terminal, and to which second authentication data has been added, from the mobile terminal, and a data coupling section coupling the first data with the second data on condition that validity of the first authentication data and the second authentication data has been confirmed.

According to one embodiment of the present disclosure, there is provided a method for information processing, including generating a specified data stream, and also generating a plurality of segment data sets by segmenting the generated specified data stream and by adding authentication data to each of the segmented data streams, and transmitting the plurality of segment data sets generated in the data generating step to respective apparatuses.

According to one embodiment of the present disclosure, there is provided a method for information processing, including acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and coupling the first data with the second data on condition that validity of the first authentication data and the second authentication data has been confirmed.

According to one embodiment of the present disclosure, there is provided a storage medium storing a computer program for making a computer execute generating a specified data stream, and also generating a plurality of segment data sets by segmenting the generated specified data stream and by adding authentication data to each of the segmented data streams, and transmitting the plurality of segment data sets generated in the data generating step to respective apparatuses.

According to one embodiment of the present disclosure, there is provided a storage medium storing a computer program for making a computer execute acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and coupling the first data with the second data on condition that validity of the first authentication data and the second authentication data has been confirmed.

According to one embodiment of the present disclosure as described in the foregoing, it becomes possible to provide new and modified information processing apparatus, terminal device, information processing system, method for information processing, and storage medium for executing information transfer while keeping confidentiality and having resistance against tampering and reuse of the information.

### BRIEF DESCRIPTION OF THE DRAWINGS

FIG. 1 is an explanatory view showing an example of an overall configuration of an information processing system 1 according to one embodiment of the present disclosure;

FIG. 2 is an explanatory view showing an example of a functional configuration of an authentication server 20 according to one embodiment of the present disclosure;

FIG. 3 is an explanatory view showing an example of a functional configuration of a POS register 210 according to one embodiment of the present disclosure;

FIG. 4 is an explanatory view showing an example of a functional configuration of a mobile phone 100 according to one embodiment of the present disclosure;

FIG. 5 is an explanatory view showing an outline of settlement processing of a commodity bill using electronic money by an information processing system 1 according to one embodiment of the present disclosure;

FIG. 6 is a flow chart showing an operation example of the information processing system 1 according to one embodiment of the present disclosure;

FIG. 7 is an explanatory view showing a format example of settlement data for use in the information processing system 1 according to one embodiment of the present disclosure;

FIG. 8 is an explanatory view showing a format example of a settlement start request for use in the information processing system 1 according to one embodiment of the present disclosure;

FIG. 9 is an explanatory view showing the process of dividing settlement data for use in the information processing system 1 according to one embodiment of the present disclosure;

FIG. 10 is an explanatory view showing an example of Ots IDs generated by the authentication server 20;

FIG. 11 is an explanatory view showing the process of coupling a segment data set A with a segment data set B generated by the authentication server 20;

FIG. 12 is an explanatory view showing one example of screens displayed on the mobile phone 100;

FIG. 13 is an explanatory view showing one example of screens displayed on the mobile phone 100;

FIG. 14 is an explanatory view showing a format example of a signature key data section included in an individual data section;

FIG. 15 is an explanatory view showing a format example of a degradation data section;

FIG. 16 is an explanatory view showing segmentation of settlement data;

FIG. 17 is an explanatory view showing restoration of settlement data;

FIG. 18 is an explanatory view showing the process of collating settlement data including authentication data restored in a store system 200 with settlement data generated in the authentication server 20 and transmitted in advance; and

FIG. 19 is a block diagram for explaining a hardware configuration of the authentication server 20 according to one embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that a description will be given in the order shown below:

<1. One Embodiment of Present Disclosure>

[Example of Overall System Configuration]

[Example of Functional Configuration of Authentication Server]

[Example of Functional Configuration of POS Register]

[Example of Functional Configuration of Mobile Phone]

[Example of System Operation]

[Example of Hardware Configuration of Authentication Server]

<2. Conclusion>

### 1. One Embodiment of Present Disclosure

### [Example of Overall System Configuration]

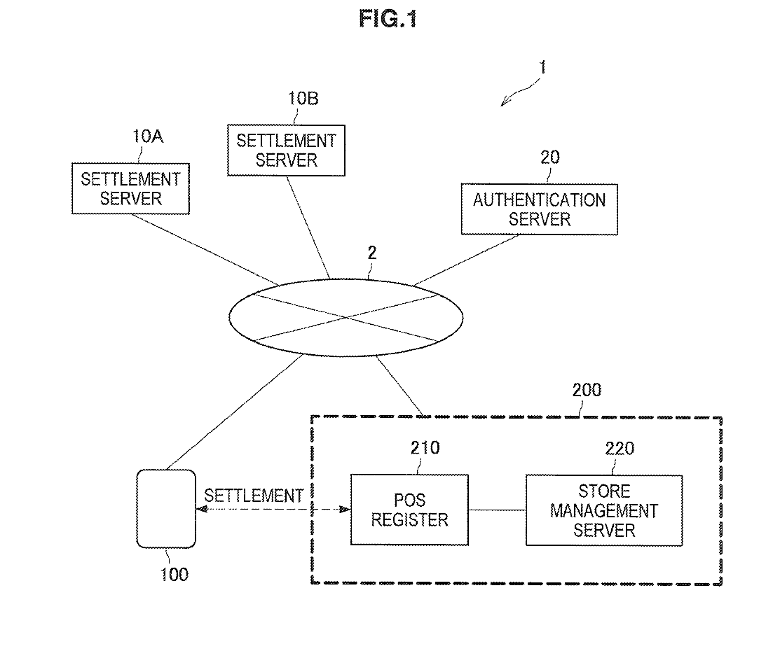

First, an example of an overall configuration of an information processing system according to one embodiment of the present disclosure will be described with reference to the drawings. FIG. 1 is an explanatory view showing an example of the overall configuration of an information processing system according to one embodiment of the present disclosure. Hereinafter, an example of the overall configuration of the information processing system 1 according to one embodiment of the present disclosure will be described with reference to FIG. 1.

As shown in FIG. 1, the information processing system 1 according to one embodiment of the present disclosure is configured to include settlement servers 10A and 10B, an authentication server 20, a mobile phone 100, and a store system 200. As shown in FIG. 1, the settlement servers 10A and 10B, the authentication server 20, the mobile phone 100, and the store system 200 are connected via a network 2 such as the Internet and a private line.

The settlement servers 10A and 10B are server apparatus for executing settlement processing by electronic money in stores. Two settlement servers 10A and 10B are illustrated in FIG. 1 to indicate that a settlement server is present for every enterprise who provides electronic money. In FIG. 1, it is indicated that two enterprises who provide electronic money are present. Note that in the following description, two settlement servers 10A and 10B may also collectively be referred to as a settlement server 10.

The authentication server 20 is a server apparatus which generates data that may be necessary for settlement processing by electronic money with use of the mobile phone 100, while executing authentication of settlement by electronic money with use of the mobile phone 100. In the present embodiment, the mobile phone 100 is an apparatus which does not have the function to perform proximity non-contact communication as described later. Since the proximity non-contact communication is a communication performed while apparatuses are in proximity to each other, the confidentiality of the information to be exchanged is extremely high. However, in order to execute settlement processing by electronic money with use of the mobile phone 100 which does not have the function to perform proximity non-contact communication, it may be necessary to exchange information while keeping the confidentiality of information for use in settlement and having resistance against tampering and reuse of information that has been used.

In the present embodiment, the authentication server 20 generates data that may be necessary for settlement processing by electronic money with use of the mobile phone 100, and segments and provides the generated data to the mobile phone 100 and the store system 200. The store system 200 couples a segment data set provided from the authentication server 20 with a segment data set provided from the authentication server 20 to the mobile phone 100 and acquired from the mobile phone 100, and requests the settlement server 10 to execute settlement by using the coupled data. Concrete methods for generating, segmenting and coupling data will be described later in detail.

The mobile phone 100 is an apparatus having a settlement function by electronic money. Note that in the present embodiment, the mobile phone 100 is an apparatus which does not have the function to perform proximity non-contact communication as described before. Therefore, it may be difficult for the mobile phone 100 to execute settlement processing through proximity non-contact communication even if the mobile phone 100 is placed over a reader writer at the time of settlement of a commodity bill by electronic money.

Accordingly, in the present embodiment, by acquiring part of the data generated by the authentication server 20 and providing the data to the store system 200, the mobile phone 100 can execute settlement of a commodity bill by electronic money without the use of proximity non-contact communication.

The store system 200 is a system provided in a store, which sells commodities, to execute settlement processing of a commodity bill. As shown in FIG. 1, the store system 200 is configured to include a POS register 210 and a store management server 220. The POS register 210 is an apparatus placed in a store to receive payment of a commodity bill from a shopper. The store management server 220 is a server placed in the backyard of a store, a data center, and the like to hold information (commodity names and prices) on commodities on sale or to collect information on settlement inputted with the POS register 210.

In the present embodiment, the POS register 210 acquires part of the data generated by the authentication server 20 at the time of settlement processing by electronic money, and also acquires part of the data, which has been generated by the authentication server 20 and acquired by the mobile phone 100, from the mobile phone 100 without the use of proximity non-contact communication. The POS register 210 then couples the data acquired from the authentication server with the data acquired from the mobile phone 100 on condition that the validity of each data has been confirmed. Since the POS register 210 couples the data in this way and requests the settlement server 10 to execute settlement, the information processing system 1 according to one embodiment of the present disclosure can implement settlement processing of a commodity bill by electronic money with use of the mobile phone 100 without the use of proximity non-contact communication.

Various forms may be considered regarding a method for the POS register 210 to acquire data from the mobile phone 100 without the use of proximity non-contact communication. For example, the POS register 210 may acquire data from the mobile phone 100 without the use of proximity non-contact communication by displaying a bar code, which uses data acquired from the authentication server 20, on the screen of the mobile phone 100 and reading the bar code with a bar code reader provided in the POS register 210. It is to be noted that displayed on the screen of the mobile phone 100 may be a one-dimensional bar code, a two-dimensional code, and may be a combination of the one-dimensional bar code and the two-dimensional code.

Note that it is not desirable from a viewpoint of security to leave data used for settlement as it is once the settlement processing by the POS register 210 is completed. It is desirable, therefore, that the data which has been generated by the authentication server 20 and provided to the mobile phone 100 or the POS register 210 is altered after completion of the settlement processing by the POS register 210 so as not to be restored. Details of which data is altered how will be described later in detail.

In the forgoing, an example of the overall configuration of the information processing system 1 according to one embodiment of the present disclosure has been described with reference to FIG. 1. A description is now given of an example of a functional configuration of the authentication server 20 according to one embodiment of the present disclosure.

### [Example of Functional Configuration of Authentication Server]

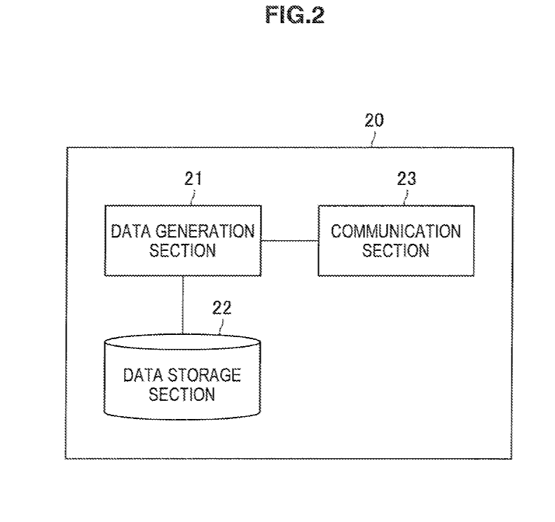

FIG. 2 is an explanatory view showing an example of the functional configuration of the authentication server 20 according to one embodiment of the present disclosure. Hereinafter, an example of the functional configuration of the authentication server 20 according to one embodiment of the present disclosure will be described with reference to FIG. 2.

As shown in FIG. 2, the authentication server 20 according to one embodiment of the present disclosure is configured to include a data generation section 21, a data storage section 22, and a communication section 23.

The data generation section 21 generates data for use in settlement processing by electronic money with use of the mobile phone 100, and also segments the generated data so as to be provided to the mobile phone 100 and the POS register 210. An example of the data generated and segmented by the data generation section 21 will be described later in detail.

The data storage section 22 stores various data sets for use at the time of data generation by the data generation section 21. The communication section 23 transmits the data generated and segmented by the data generation section 21 to the mobile phone 100 and the POS register 210 via the network 2.

Since the authentication server 20 has such a configuration, the authentication server 20 can generate data for executing settlement processing by electronic money with use of the mobile phone 100 that does not perform proximity non-contact communication, and can provide the data to the mobile phone 100 and the POS register 210.

In the foregoing, an example of the functional configuration of the authentication server 20 according to one embodiment of the present disclosure has been described with reference to FIG. 2. A description is now given of an example of a functional configuration of the POS register 210 according to one embodiment of the present disclosure.

### [Example of Functional Configuration of POS Register]

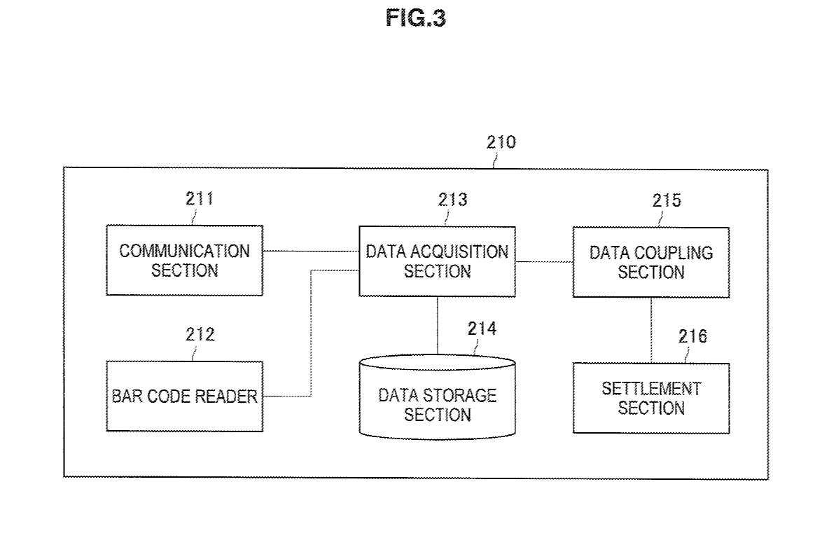

FIG. 3 is an explanatory view showing an example of a functional configuration of the POS register 210 according to one embodiment of the present disclosure. Hereinafter, an example of the functional configuration of the POS register 210 according to one embodiment of the present disclosure will be described with reference to FIG. 3.

As shown in FIG. 3, the POS register 210 according to one embodiment of the present disclosure is configured to include a communication section 211, a bar code reader 212, a data acquisition section 213, a data storage section 214, a data coupling section 215, and a settlement section 216.

The communication section 211 performs communication through the network 2. In the present embodiment, the communication section 211 receives the data generated and segmented by the authentication server 20 through the network 2. The communication section 211 provides the data received from the authentication server 20 to the data acquisition section 213.

The bar code reader 212 reads a bar code and converts the read bar code into corresponding data. The bar code reader 212 provides the data acquired by reading the bar code to the data acquisition section 213. In the present embodiment, the bar code reader 212 reads a bar code attached to a commodity as well as a bar code displayed on the screen of the mobile phone 100, converts the read bar code into corresponding data, and provides the data to the data acquisition section 213.

The data acquisition section 213 acquires data from the communication section 211 and the bar code reader 212. The data acquisition section 213 stores the acquired data in the data storage section 214 if desired. In order to couple the data sets acquired from the authentication server 20 and the data from the mobile phone 100 at the time of settlement processing by electronic money with use of the mobile phone 100, the data acquisition section 213 provides the acquired data to the data coupling section 215.

The data storage section 214 stores data acquired by the data acquisition section 213 and various data sets that may be necessary at the time of settlement processing of a commodity bill. The various data sets that may be necessary at the time of settlement processing of a commodity bill include, for example, information on a commodity price, and information on a salesclerk who operates the POS register 210. Note that the various data sets that may be necessary at the time of settlement processing of a commodity bill may be stored not inside the POS register 210 but inside the store management server 220.

The data coupling section 215 couples the data sets which are provided from the data acquisition section 213 and acquired from the authentication server 20 and the mobile phone 100. When the data coupling section 215 couples the data sets acquired from the authentication server 20 and the mobile phone 100, the data coupling section 215 couples the two data sets on a condition that the validity of each data has been confirmed. The condition for the data coupling section 215 to couple data sets will be described later in detail. Once the validity of two data sets is confirmed and so the data sets are coupled, the data coupling section 215 provides the coupled data to the settlement section 216.

The settlement section 216 executes settlement processing of a commodity bill. In the present embodiment, at the time of settlement processing by electronic money with use of the mobile phone 100, the settlement section 216 uses the data coupled by the data coupling section 215 to request the settlement server 10 to execute settlement processing and to receive a returned result of the settlement processing from the settlement server 10.

Since the POS register 210 is thus-configured, it becomes possible to execute settlement processing by electronic money with use of the mobile phone 100 which does not perform proximity non-contact communication.

In the foregoing, an example of the functional configuration of the POS register 210 according to one embodiment of the present disclosure has been described with reference to FIG. 3. A description is now given of an example of a functional configuration of the mobile phone 100 according to one embodiment of the present disclosure.

### [Example of Functional Configuration of Mobile Phone]

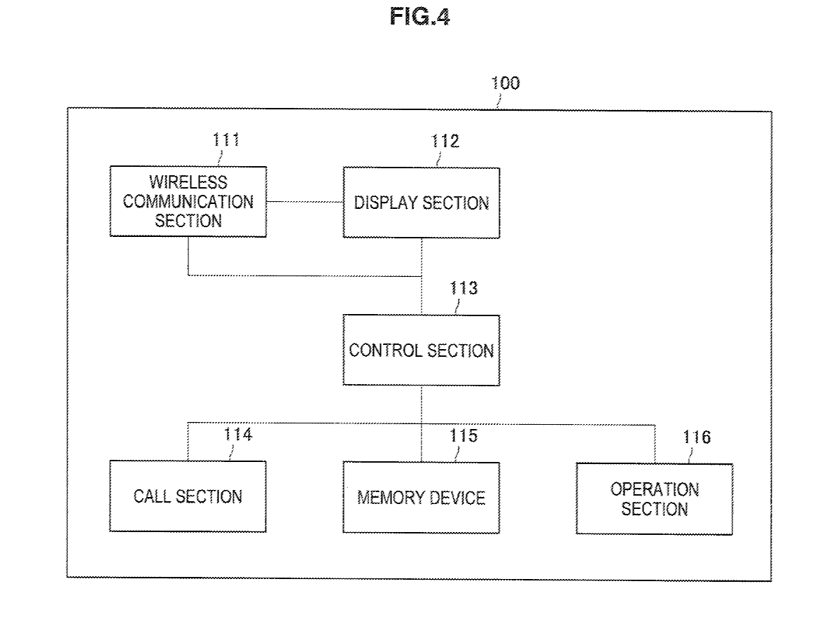

FIG. 4 is an explanatory view showing an example of the functional configuration of the mobile phone 100 according to one embodiment of the present disclosure. Hereinafter, an example of the functional configuration of the mobile phone 100 according to one embodiment of the present disclosure will be described with reference to FIG. 4.

As shown in FIG. 4, the mobile phone 100 according to one embodiment of the present disclosure is configured to include a wireless communication section 111, a display section 112, a control section 113, a call section 114, a memory device 115, and an operation section 116.

The wireless communication section 111 performs wireless communication with other apparatuses through a wireless network. The display section 112 displays information that the wireless communication section 111 received, and information corresponding to operation of a user performed on the operation section 116. The display section 112 is formed from a flat-type image display panel, such as a liquid crystal display and an organic EL display. In the present embodiment, the display section 112 may include a touch panel.

The control section 113 controls operation of the mobile phone 100. For example, the control section 113 controls operation of the mobile phone 100 by executing a program stored in the memory device 115. The control section 113 controls operation of the mobile phone 100 by, for example, execution of an application for executing settlement processing by electronic money, and the like.

The call section 114 includes, for example, a speaker and a microphone to make a voice call with another mobile phone or a telephone set. The memory device 115 includes, for example, a ROM (Read Only Memory) and a RAM (Random Access Memory) for use in storing a program for controlling operation of the mobile phone 100, or the like. The operation section 116 includes a button for operating the mobile phone 100. In response to the operation performed on the operation section 116, the operation of the mobile phone 100 is controlled by the control section 113. Note that a touch panel, if provided in the display section 112, also functions as the operation section 116.

In the present embodiment, for settlement of a commodity bill by electronic money, the mobile phone 100 acquires data from the authentication server 20 and provides the data to the POS register 210. There are various methods for providing the data acquired from the authentication server 20 to the POS register 210. For example, the mobile phone 100 converts the data acquired from the authentication server 20 into visualized and thereby readable information such as a bar code. The information is read by the POS register 210, and settlement data is restored in the POS register 210 so that settlement can be implemented. As a consequence, the mobile phone 100 can make a settlement of a commodity bill by using electronic money without the use of proximity non-contact communication.

In the foregoing, an example of the functional configuration of the mobile phone 100 according to one embodiment of the present disclosure has been described with reference to FIG. 4. A description is now given of the operation of the information processing system 1 according to one embodiment of the present disclosure and a format example of the data for use in the information processing system 1 according to one embodiment of the present disclosure.

### [Example of System Operation]

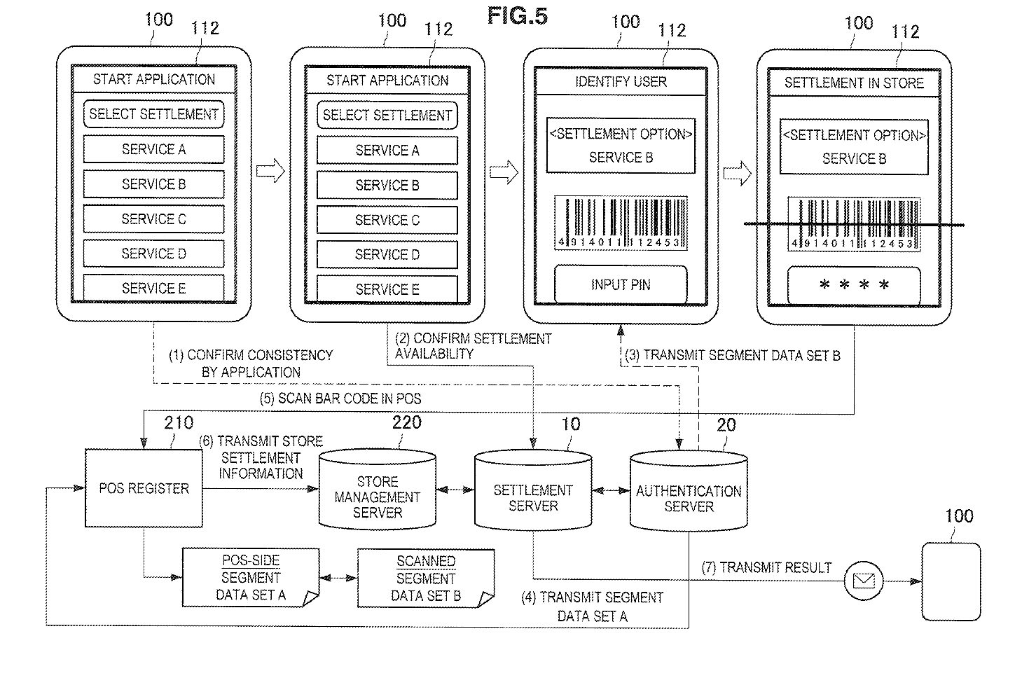

FIG. 5 is an explanatory view showing an outline of settlement processing of a commodity bill by the information processing system 1 according to one embodiment of the present disclosure by using electronic money. Hereinbelow, a description is given of an outline of settlement processing of a commodity bill by the information processing system 1 according to one embodiment of the present disclosure by using electronic money with reference to FIG. 5.

In the present embodiment, in order to settle a commodity bill by using electronic money with use of the mobile phone 100, the mobile phone 100 executes, for example, an application for using electronic money (hereinafter also simply referred to as “the application”). Once the application is started, the mobile phone 100 first displays, as shown in FIG. 5, a screen for a user to select an electronic money service for use in settlement on the display section 112. FIG. 5 shows the state where five electronic money service options for use in settlement are displayed on the display section 112.

Note that once the application is executed in the mobile phone 100, the application executed in the mobile phone 100 may refer to the authentication server 20 to confirm the consistency of the application as shown in FIG. 5 (1). By referring to the authentication server 20 to confirm the consistency of the application, it becomes possible to confirm whether or not the application is of the latest version and whether or not the application is the one regularly issued.

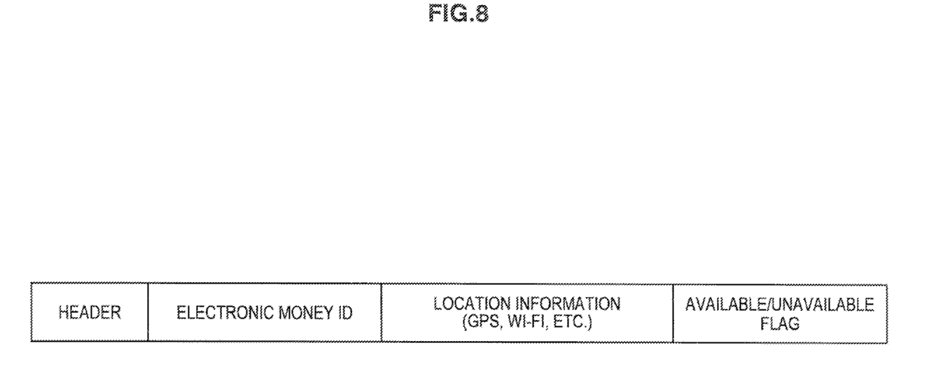

A user can select, out of the electronic money service options displayed on the display section 112, an electronic money service for use in settlement. Note that the electronic money service options may include, for example, a postpaid electronic money service besides a prepaid electronic money service. The mobile phone 100 then makes an inquiry about whether or not the electronic money service selected by the user is available to the settlement server 10 that executes settlement processing of the electronic money service selected by the user as shown in FIG. 5 (2). In FIG. 5, the state where a user has selected a service B is shown. The mobile phone 100 refers to the settlement server 10, which executes settlement processing of the service B that has been selected by the user, to confirm whether or not the service B is available. Whether or not the service B is available is determined based on, for example, whether or not the service itself is available and whether or not the balance is positive if the service itself is available. Further, if a settlement start request shown in FIG. 8 is transmitted to the settlement server 10 together with the inquiry, a settlement execution store can be specified, which makes it possible to identify a target POS register 210 to which a segment data set is to be sent.

If the electronic money service selected by the user is available, the settlement server 10 requests the authentication server 20 to generate data (settlement data) for settlement. In that case, a destination store to send a segment data set is specified by transferring data on the settlement start request shown in FIG. 8. The authentication server 20 which has received the settlement data generation request from the settlement server 10 generates settlement data corresponding to the request, and also segments the authentication data including the settlement data and transmitting segment data sets to the mobile phone 100 and the POS register 210. In the following description, the data sent from the authentication server 20 to the POS register 210 is defined as a segment data set A and the data sent to the mobile phone 100 is defined as a segment data set B.

Upon reception of the segment data set B from the authentication server 20, the mobile phone 100 generates a bar code that makes the received segment data set B readable with the application and displays the generated bar code on the display section 112. At the time of generating the bar code, the application executed in the mobile phone 100 may make a user input PIN (Personal Identification Number; password). It is to be noted that timing to make a user input the PIN is not limited to specific timing. For example, timing to make a user input the PIN may be at the time when an application is started, when an electronic money service is selected, or the like.

The POS register 210 of the settlement execution store, which is specified from a data stream of the settlement start request, receives the segment data set A from the authentication server 20, and further acquires the segment data set B by reading a bar code displayed on the display section 112 of the mobile phone 100 with the bar code reader 212. The POS register 210 determines the validity of the segment data set A and the segment data set B, and if the segment data sets are determined to be proper, the POS register 210 couples the segment data set A and the segment data set B to restore settlement data. Once the settlement data is restored, the POS register 210 transmits store settlement information including the restored settlement data to the store management server 220. The store management server 220 transmits the store settlement information sent from the POS register 210 to the settlement server 10, and requests settlement processing of a bill. Once the settlement processing of the bill is executed by the settlement server 10, the result is sent to the POS register 210 via the store management server 220. The POS register 210 receives the result of the settlement processing in the settlement server and displays the result on the screen present so that success or failure of the settlement processing by electronic money can be presented to a salesclerk or a user of the mobile phone 100.

Once the settlement processing by electronic money is completed, the settlement server 10 may transmit the result of the settlement processing to the mobile phone 100 through e-mail and the like. Information transmitted from the settlement server 10 to the mobile phone 100 may include information on the used amount of electronic money and on the balance of electronic money, besides the result of settlement processing. By transmitting the result of settlement processing to the mobile phone 100, the settlement server 10 can notify a user of the mobile phone 100 of a status of use of electronic money.

In the foregoing, a description has been given of the outline of settlement processing of a commodity bill by the information processing system 1 according to one embodiment of the present disclosure by using electronic money with reference to FIG. 5. A description is now given of concrete operation of the information processing system 1 according to one embodiment of the present disclosure.

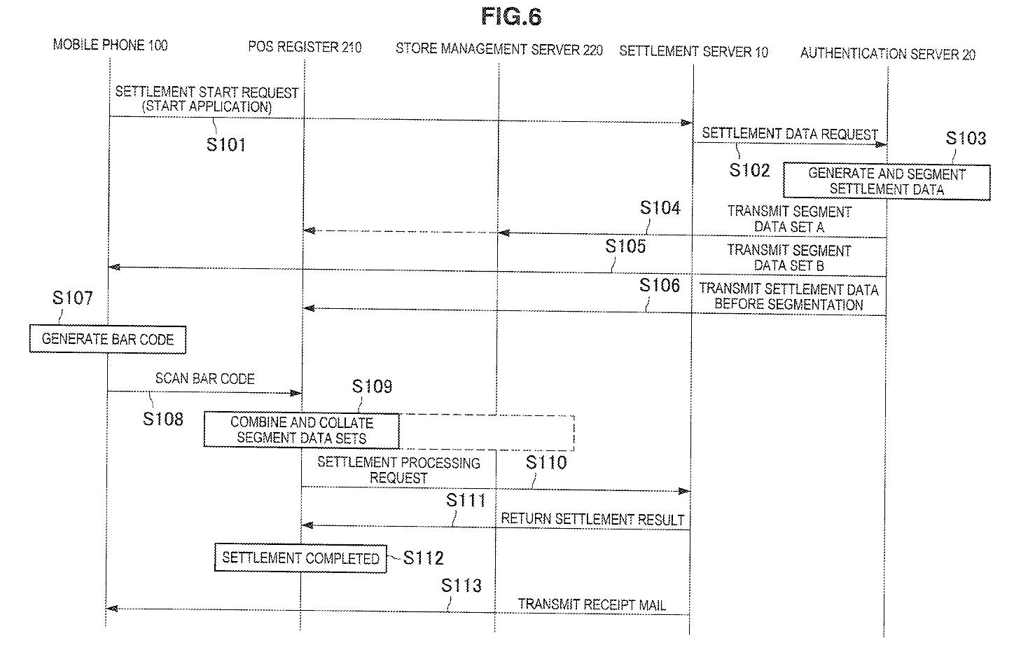

FIG. 6 is a flow chart showing an operation example of the information processing system 1 according to one embodiment of the present disclosure. Hereinafter, concrete operation of the information processing system 1 according to one embodiment of the present disclosure will be described with reference to FIG. 6.

In order to execute settlement processing by electronic money, the mobile phone 100 starts an application as shown in FIG. 5, and requests the settlement server 10 to start settlement (Step S101). At the time of settlement processing by electronic money, available electronic money service options are presented; an electronic money service is selected by a user; availability of the selected electronic money service is determined; and information on a store where settlement is executed is transmitted as shown in FIG. 5.

The settlement server 10 which received the settlement start request from the mobile phone 100 requests the authentication server 20 to generate settlement data for settlement processing by electronic money with use of the mobile phone 100 (Step S102). Upon reception of the settlement data generation request from the settlement server 10, the authentication server 20 generates, in the data generation section 21, authentication data including the settlement data for settlement processing by electronic money with use of the mobile phone 100, and also segments the generated authentication data in the middle of the settlement data to make a segment data set A and a segment data set B (Step S103).

Once the authentication data including the settlement data is generated and the authentication data is segmented in the middle of the settlement data, the authentication server 20 transmits the respective segment data sets A and B to the store system 200 (the POS register 210 or the store management server 220) and to the mobile phone 100, and transmits the settlement data before segmentation to the store system 200 (the POS register 210) with use of the communication section 23 (Steps S104, S105, S106). In the present embodiment, as mentioned above, a segment data set transmitted from the authentication server 20 to the store system 200 is defined as the segment data set A and a segment data set transmitted from the authentication server 20 to the mobile phone 100 is defined as the segment data set B.

Upon reception of the segment data set B from the authentication server 20, the mobile phone 100 generates a bar code for providing the segment data set B to the POS register 210 (Step S107). The bar code is generated under the control of the control section 113 that executes the application for executing settlement by electronic money with the mobile phone 100.

The mobile phone 100 displays the generated bar code on the display section 112. The POS register 210 scans the bar code displayed on the display section 112 with the bar code reader 212 (Step S108), and acquires the segment data set B from the mobile phone 100. Upon acquisition of the segment data set B from the mobile phone 100, the POS register 210 determines, in the data coupling section 215, the validity of the segment data set B as well as the segment data set A transmitted from the authentication server 20 in step S104. If the data sets are proper, the POS register 210 couples the segment data set A with the segment data set B in the data coupling section 215 (Step S109).

Further, the POS register 210 may acquire settlement data generated by the authentication server 20, and may collate the acquired settlement data with the settlement data included in the obtained-by-coupling data (Step S109). By collating the settlement data acquired from the authentication server 20 with the settlement data included in the obtained-by-coupling data, the POS register 210 can determine the validity of the data obtained by coupling data sets in the data coupling section 215.

In step S109, the segment data set A and the segment data set B are coupled, and the settlement data acquired from the authentication server 20 and the settlement data, which is included in the data obtained by coupling data sets in the data coupling section 215, are collated. If it is confirmed that the settlement data is proper, the POS register 210 transmits store settlement information including the settlement data to the settlement server 10, and thereby requests the settlement server 10 to execute settlement processing of a commodity bill (Step S110). The settlement server 10 executes settlement by electronic money with use of the store settlement information sent from the POS register 210, and returns a settlement result to the POS register 210 (Step S111). The POS register 210 uses the information on the settlement result sent from the settlement server 10 to complete the settlement on the store side in the settlement section 216 (Step S112).

The settlement server 10 also transmits the result of settlement by electronic money to the mobile phone 100 through e-mail (Step S113).

As each apparatus executes processing as shown in FIG. 6, the information processing system 1 according to one embodiment of the present disclosure can implement settlement of a commodity bill by electronic money with use of the mobile phone 100 which does not have a proximity non-contact communication function. Since settlement of a commodity bill by electronic money can be executed without the use of the proximity non-contact communication function, it becomes possible to provide a user, who uses the mobile phone 100 which does not have the proximity non-contact communication function, with convenience equivalent to the convenience provided in the case of using a mobile phone which has the proximity non-contact communication function.

Now, a description is given of a format example of settlement data for use in the information processing system 1 according to one embodiment of the present disclosure. Note that in the drawings used in the following explanation, numeric characters shown in the format of data are expressed in units of byte.

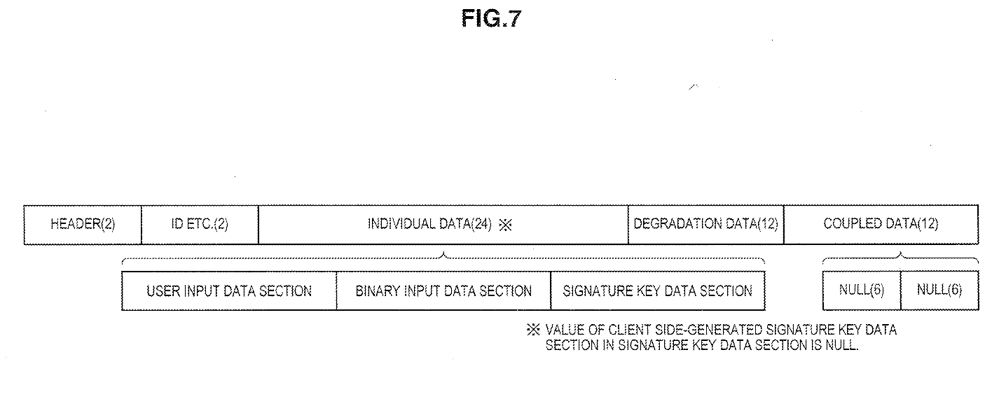

FIG. 7 is an explanatory view showing a format example of authentication data for use in the information processing system 1 according to one embodiment of the present disclosure. The authentication data for use in the information processing system 1 is data which is generated in the authentication server 20 in response to the request from the settlement server 10 at the time of settlement by electronic money. As shown in FIG. 7, the authentication data for use in the information processing system 1 includes a header, an ID, and individual data, and degradation data. The individual data included in the authentication data includes a user input data section, a binary input data section, and a signature key data section as shown in FIG. 7.

The header portion stores information indicating that subsequent data is authentication data and other header information for use in the information processing system 1. The ID portion stores ID information of electronic money for use in settlement with the mobile phone 100.

The user input data section stores alphabetic characters, numeric characters, symbols, and other input data inputted by a user in advance at the time when the user performs a use registration of an electronic money service. The binary input data section stores data generated from the information inputted by a user when the user performs a use registration of the electronic money service. An example of the data stored in the user input data section and an example of the data stored in the binary input data section will be described later in detail.

The signature key data section stores a signature key for use in using the electronic money service. As described later in detail, in the present embodiment, the signature key data section includes a server side-generated signature key data section and a client side-generated signature key data section. The information processing system can prevent spoofing on the client side by dividing the signature key data section into a server side-generated signature key data section and a client side-generated signature key data section. Note that an initial value of the client side-generated signature key data section in the signature key data section is NULL. In the present disclosure, the client side-generated signature key data section may be set to take a value of zero by default.

In the degradation data section, new data is stored whenever the electronic money service is used. As for the data stored in the degradation data section, a part or all of a pre-defined data stream is altered (degraded) when settlement of a commodity bill by electronic money is completed. The information processing system 1 can prevent reuse of the same data by altering the data stored in the degradation data section after the settlement of a commodity bill by electronic money. It is also possible to so set that the data in the degradation data section is valid only in a fixed time period. Altering the data after lapse of a fixed time period makes it possible to prevent the generated settlement data from being abused even when no settlement is executed.

FIG. 8 is an explanatory view showing a format example of the settlement start request for use in the information processing system 1 according to one embodiment of the present disclosure. The settlement start request shown in FIG. 8 is data which is sent from the mobile phone 100 to the settlement server 10 at the time of executing settlement of a commodity bill by electronic money with use of the mobile phone 100, and which is sent from the mobile phone 100 to the settlement server 10 at Step S101 of FIG. 6.

As shown in FIG. 8, the settlement start request sent from the mobile phone 100 to the settlement server 10 includes a header, an electronic money ID, location information, and an available/unavailable flag. The header portion stores information indicating that subsequent data is a settlement start request and other header information for use in the information processing system 1. The electronic money ID portion stores ID information of electronic money for use in settlement with the mobile phone 100. The location information portion stores location information of the mobile phone 100 that the mobile phone 100 acquired from GPS, Wi-Fi, or the like. Transmitting a data stream, which includes the location information, from the mobile phone 100 to the settlement server 10 makes it possible to specify a destination store to which the settlement data and the segment data set are transmitted. The available/unavailable flag portion stores information about whether the electronic money service selected with the mobile phone 100 is available or not.

The authentication data for use in the information processing system 1 according to one embodiment of the present disclosure has a format as shown in FIG. 7 for example. As described above, in the information processing system 1 according to one embodiment of the present disclosure, the authentication server 20 segments the authentication data and transmits respective segment data sets to the mobile phone 100 and the store system 200. In that case, if data is simply segmented and transmitted to the mobile phone 100 and to the store system 200, the transmission destination apparatuses hardly have the resistance against tampering of information.

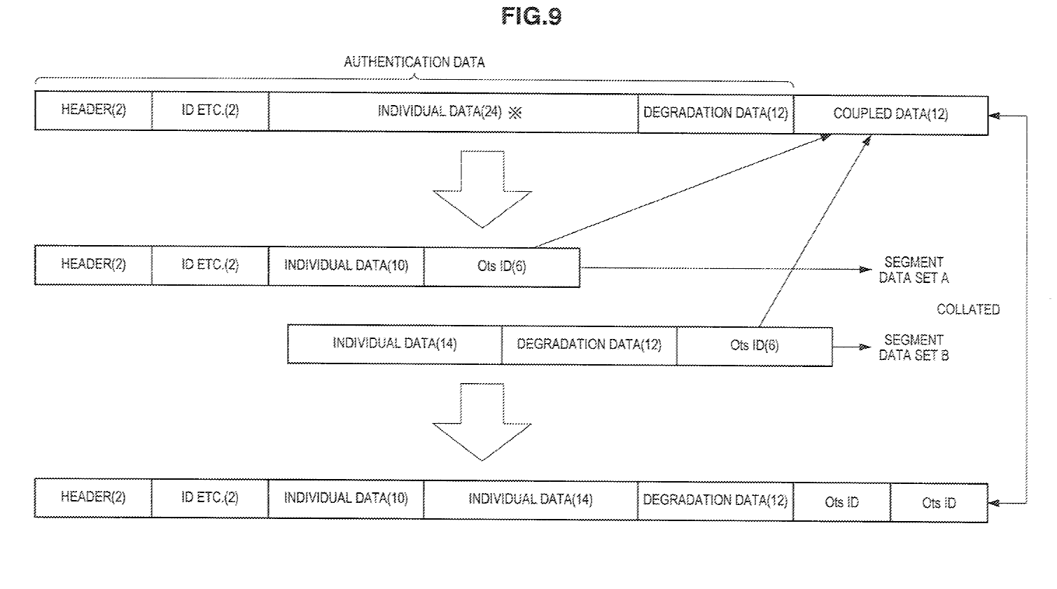

Accordingly, in the information processing system 1 according to one embodiment of the present disclosure, data for settlement processing by electronic money which is valid only once is added to a tail of post-segmented data by the data generation section 21 at the time of segmenting the settlement data in the authentication server 20. FIG. 9 is an explanatory view showing the process of segmenting settlement data for use in the information processing system 1 according to one embodiment of the present disclosure. The authentication data which is valid only once in the settlement processing by electronic money is defined as “One Time Session ID (Ots ID)” in the present embodiment. The authentication server 20 segments the settlement data formatted as shown in FIG. 7, and adds an Ots ID to each of segmented data sets.

In the present embodiment, as shown in FIG. 9, the authentication server 20 segments authentication data in the middle of settlement data in the data generation section 21, and the data generation section 21 generates 6-byte Ots IDs based on a specified rule and adds each ID to each tail of the segmented data sets. The authentication server 20 couples the Ots IDs, which have been added to the respective segmented data sets in the data generation section 21, as 12-byte coupled data, and adds the coupled data to the tail of the settlement data in the data generation section 21.

The authentication server 20 transmits segment data sets, each having an Ots ID added thereto, to the mobile phone 100 and to the store system 200. As described above, a segment data set transmitted from the authentication server 20 to the store side is defined as the segment data set A and a segment data set transmitted from the authentication server 20 to the mobile phone 100 is defined as the segment data set B.

If the Ots IDs of the segment data set A and the segment data set B are proper, the store system 200 couples the segment data set A with the segment data set B in the POS register 210 to restore authentication data. The store system 200 then collates the restored settlement data with the ante-segmentation settlement data generated in the authentication server 20 to determine the validity of the restored settlement data.

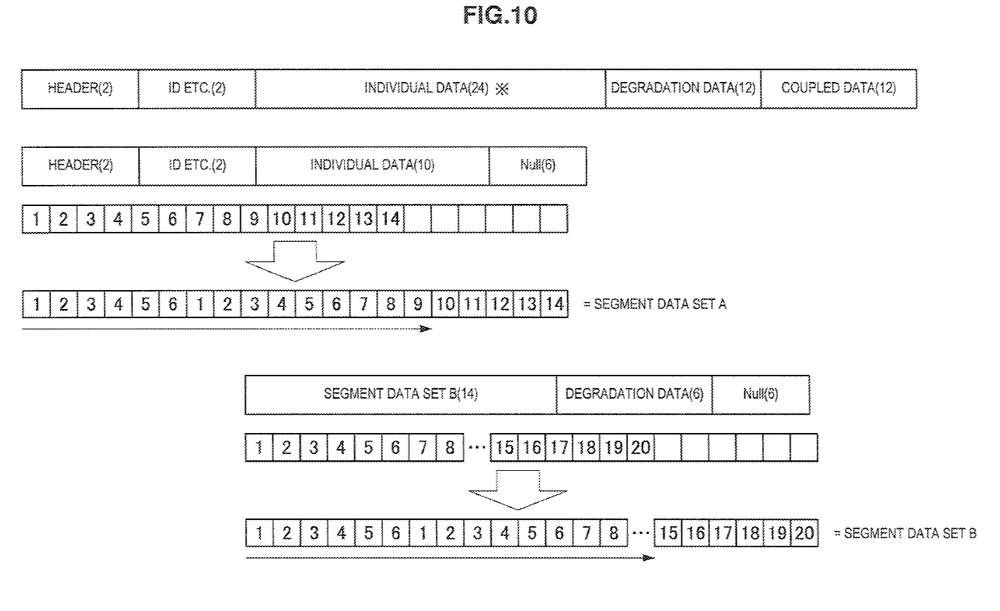

Here, an example of generating the Ots IDs will be described. FIG. 10 is an explanatory view showing an example of Ots IDs generated by the authentication server 20. In the present embodiment, in order to add an Ots ID to the tail of the segmented data, the data generation section 21 shifts the segmented data to the right side by 6 bytes, and uses a trailing 6-byte portion of the segmented data for the Ots ID. More specifically, in the case of the segment data set A, the trailing 6-byte portion in the segmented individual data serves as the Ots ID, whereas in the case of the segment data set B, 6 bytes that constitute the degradation data serve as the Ots ID. In the following description, the Ots ID of the segment data set A is referred to as an Ots ID-A, and the Ots ID of the segment data set B is referred to as an Ots ID-B. In the present disclosure, without being limited to the above example, data such as a value same as the Ots ID generated in the segment data set B may be written in the segment data set A. According to this approach, processing in the POS register 210 can be simplified since the perfect match between the Ots IDs can simply be used as the basis for confirming the consistency of the segment data sets which have been loaded onto the POS register 210.

Thus, the authentication server 20 transmits the segment data sets A and B, which have been generated by adding respective Ots IDs thereto, to the store system 200 and to the mobile phone 100, so that the data sets are to be used in settlement of a commodity bill by using electronic money with the mobile phone 100.

It should naturally be understood that generation of Ots IDs by the authentication server 20 is not limited to the generation disclosed in the example. The authentication server 20 may generate Ots IDs by using part of each segment data set, that is, for example, data at a specific location of the segmented data streams.

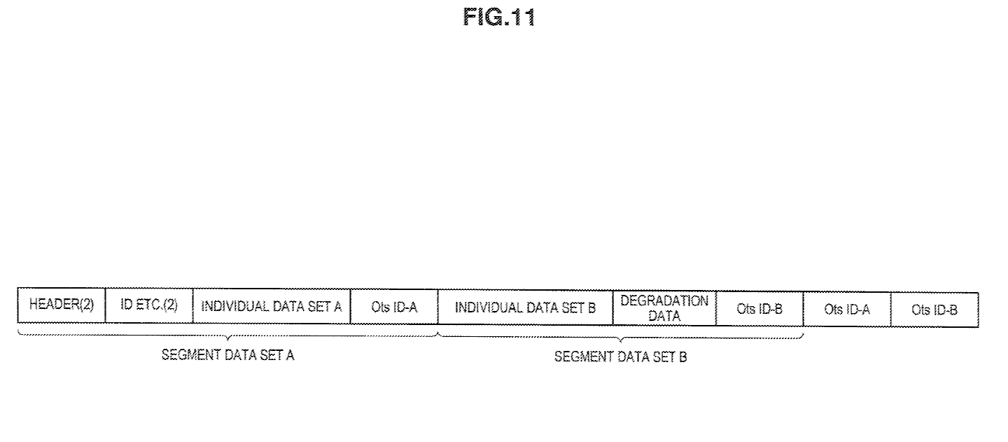

FIG. 11 is an explanatory view showing the process of coupling a segment data set A with a segment data set B, which have been generated by the authentication server 20, in the POS register 210. To determine the validity of the segment data sets A and B, the POS register 210 collates the content of respective Ots IDs with the content of data used as a basis of the Ots IDs. In the example of FIG. 11, where trailing 6 bytes of each segmented data set are used as the Ots ID, the POS register 210 determines that the segment data sets A and B are proper when the 6-byte tail of the settlement data A matches with the Ots ID-A, and when the 6-byte tail of the settlement data B matches with the Ots ID-B. Therefore, it is assumed that the POS register 210 shares an Ots ID generation rule with the authentication server 20. In the case where the same Ots IDs are used in the segment data sets A and B, the POS register 210 can determine that the segment data sets A and B are proper segment data sets generated by the authentication server 20 if the Ots ID-A and the Ots ID-B reach a perfect match.

Once the POS register 210 confirms the contents of the Ots IDs and concludes that the contents of the Ots IDs are proper, the POS register 210 couples the segment data set A with the segment data set B in the data coupling section 215. Note that the POS register 210 removes the Ots IDs when coupling the segment data set A with the segment data set B in the data coupling section 215. Next, the coupling section 215 adds the removed Ots IDs to the tail end of a coupled data stream. This makes it possible to restore the settlement data for use in settlement of a commodity bill by using electronic money with the mobile phone 100.

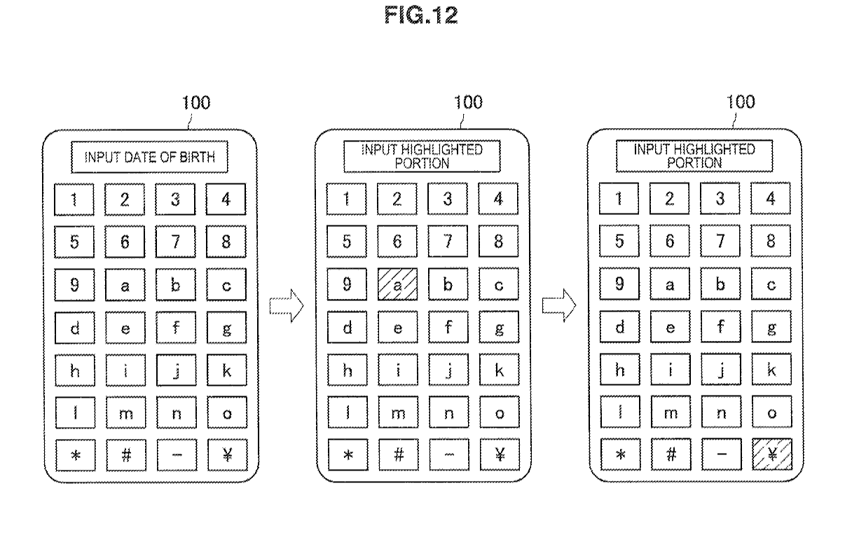

A description is now given of an input example of the user input data section included in the individual data section. FIG. 12 is an explanatory view showing one example of screens displayed on the mobile phone 100. FIG. 12 shows an example of screens of the application for executing settlement of a commodity bill by electronic money with use of the mobile phone 100. At the time of registration of an electronic money service with use of the mobile phone 100, the authentication server 20 first makes a user input personal information, such as a date of birth, and then makes the user of the mobile phone 100 input alphabetic characters displayed at random by the application so as to use the inputted information as the data to be stored in the user input data section.

FIG. 12 shows an example in which a user of the mobile phone 100 is made to select, out of alphabetic characters currently displayed, a highlighted portion that is used as user input data to be stored in the user input data section. For example, the application first highlights “a” and once the user of the mobile phone 100 is made to select “a,” the application then highlights “\” to make the user of the mobile phone 100 select “\.” Thus, the authentication server 20 makes the user of the mobile phone 100 input a predetermined number of alphabetic characters displayed at random by the application, and thereby generates the user input data section included in the settlement data section.

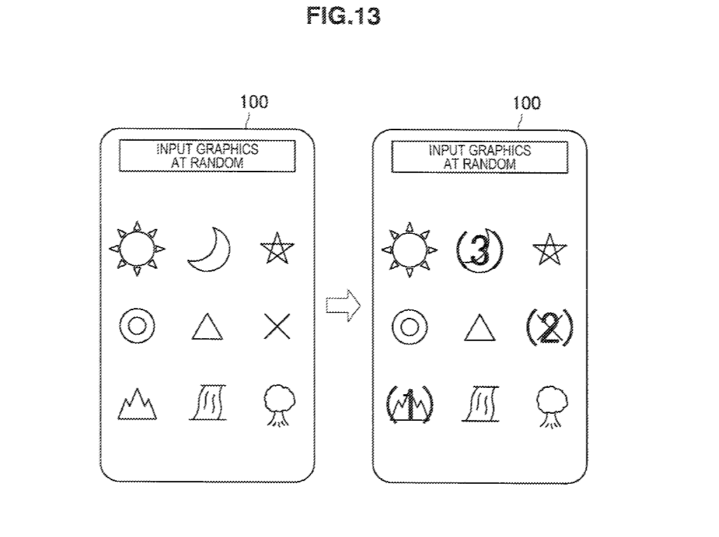

A description is now given of an input example of the binary input data section included in the individual data section. FIG. 13 is an explanatory view showing one example of screens displayed on the mobile phone 100. FIG. 13 shows an example of screens of the application for executing settlement of a commodity bill by electronic money with use of the mobile phone 100. When a user of the mobile phone 100 uses an electronic money service, the authentication server 20 displays icons on the screen of the mobile phone 100 by the application, and makes the user select the icons freely.

For example, nine icons are displayed on the screen in FIG. 13, where the application makes the user of the mobile phone 100 select icons in the order as he/she likes. The application transmits the order of the icons selected by the user to the authentication server 20. The authentication server 20 generates data to be stored in the binary input data section based on the order of the icons selected by the user of the mobile phone 100.

The icons displayed on the display section 112 of the mobile phone 100 by the application are desirably altered on a periodic basis. A plurality of icons may be displayed on the display section 112 of the mobile phone 100 by the application, and which icon to be list-displayed on the display section 112 may be determined at random.

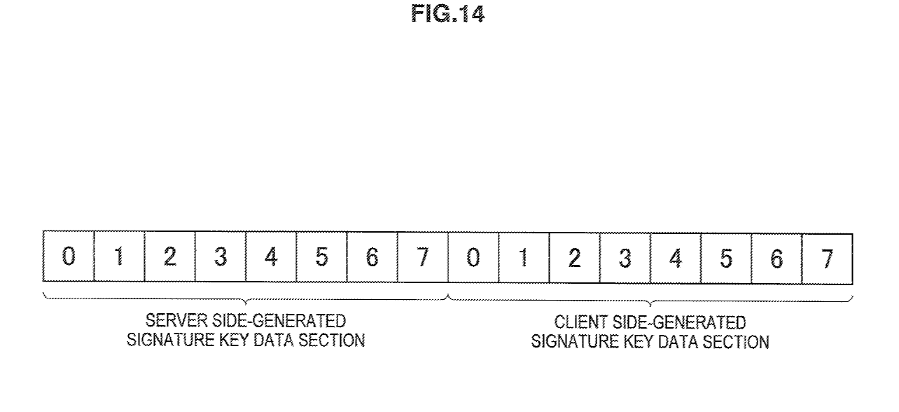

A description is now given of the data to be stored in the signature key data section included in the individual data section. FIG. 14 is an explanatory view showing a format example of the signature key data section included in the individual data section. In the present embodiment, the signature key data section has, for example, a byte length of 16 bytes. The signature key data section has an 8-byte server side-generated signature key data section, and an 8-byte client side-generated signature key data section, respectively. Part of previous settlement data may be written in the server side-generated signature key data section for example. If part of the previous settlement data are written in the server side-generated signature key data section, the signature key data section is updated as different signature data every time the settlement is completed. In the information processing system 1 according to the present embodiment, segmenting the signature key data section in this way makes it possible to prevent spoofing on the client side.

The authentication server 20 writes, with use of the data generation section 21, data sets, each enciphered with a secret key, in the server side-generated signature key data section and the client side-generated signature key data section, respectively. The authentication server 20 does not write, with use of the data generation section 21, the same data in the client side-generated signature key data section on the constant basis, but updates a key value with predetermined frequency (e.g., every 24 hours). By updating the key value of the client side-generated signature key data section with predetermined frequency, it becomes possible to prevent spoofing and counterfeiting based on reverse engineering analysis on the client side.

Based on the data inputted and generated in this way, the authentication server 20 stores data in the individual data section. For example, the authentication server 20 stores, with use of the data generation section 21, a character string that the user of the mobile phone 100 has been made to input in the user input data section. The size of the user input data section may be 2 bytes, for example. The authentication server 20 then stores in the binary input data section, with use of the data generation section 21, every first 8-bit part of binary values that correspond to the icons in the order that the user of the mobile phone 100 selected. The size of the binary input data section may be 2 bytes, for example. The authentication server 20 then stores signature key data in the signature key data section, and generates 24-byte settlement data in the data generation section 21.

The authentication server 20 enciphers the 24-byte individual data thus-generated in the data generation section 21 with a public key provided by an enterprise who provides the electronic money service. Even if data is intercepted, enciphering the settlement data makes it possible to prevent the intercepted data from being abused.

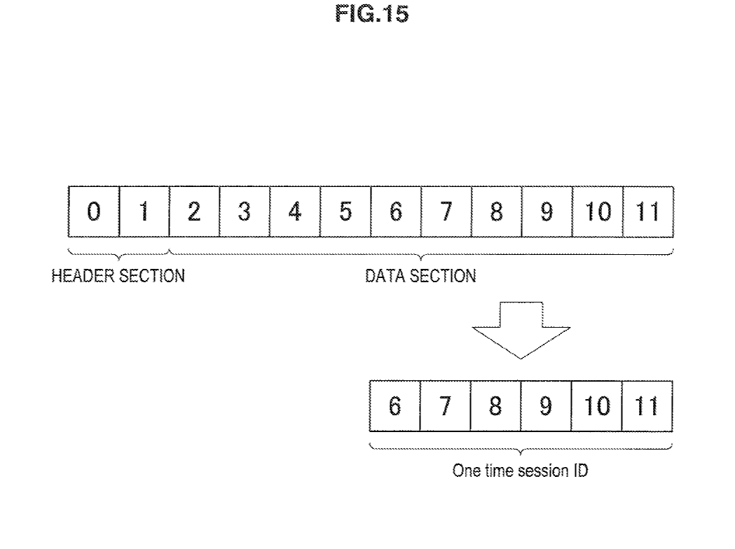

A description is now given of the degradation data generated by the authentication server 20. FIG. 15 is an explanatory view showing a format example of the degradation data section. In the present embodiment, the degradation data section has a data length of 12 bytes, which is made up of a 2-byte header section and a 10-byte data section. The authentication server 20 stores, in the header section of the degradation data section, information on degradation of the content of the data section. The information on degradation of the content of the data section may include, for example, the number of times the content of the data section takes for degradation and a period of time until data degradation. For example, to degrade the content of the data section immediately after coupling of the segment data sets, the authentication server 20 stores information for achieving such degradation of the content. The authentication server 20 then stores appropriate data in the data section. The data section in the degradation data section contains data used as a basis of Ots IDs as mentioned above.

Note that the thus-generated authentication data is to be valid only for a predetermined time (e.g., only for 5 minutes). If the authentication data is valid only for a predetermined time, it becomes possible to prepare for settlement by electronic money before execution of the settlement. In addition, since the data value is altered after the predetermined time, it becomes possible to prevent unjust use of the service caused by the same data being repeatedly used.

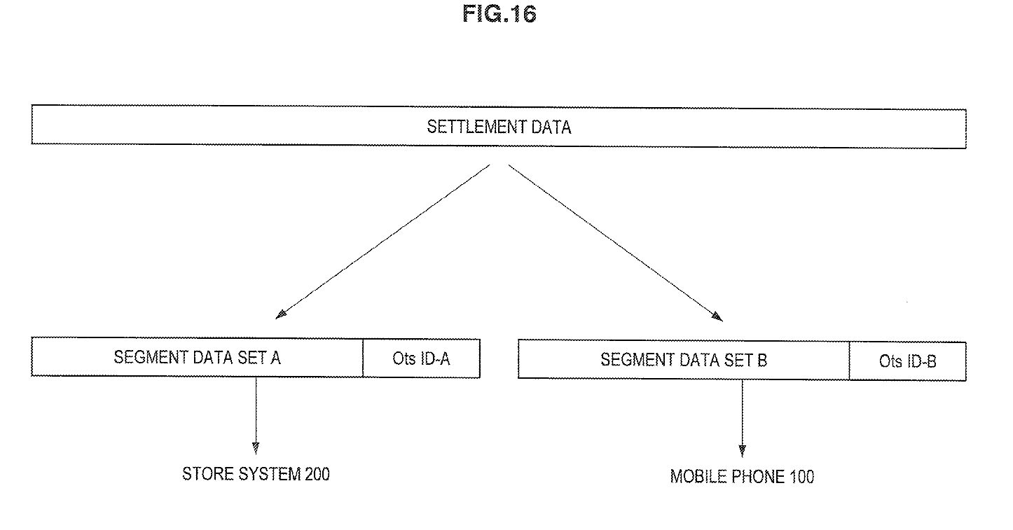

The authentication server 20 segments and transmits the thus-generated settlement data to different apparatuses. FIG. 16 is an explanatory view showing segmentation of the settlement data. The authentication server 20 segments the authentication data and adds Ots IDs to generate segment data sets A and B. The segment data set A is transmitted to the store system 200, while the segment data set B is transmitted to the mobile phone 100. Although the authentication server 20 segments the authentication data into two segments in the present embodiment, the present disclosure is not limited to the example disclosed. As long as three or more apparatuses are operated in cooperation at the time of settlement, the authentication server 20 may segment the authentication data into three or more segments.

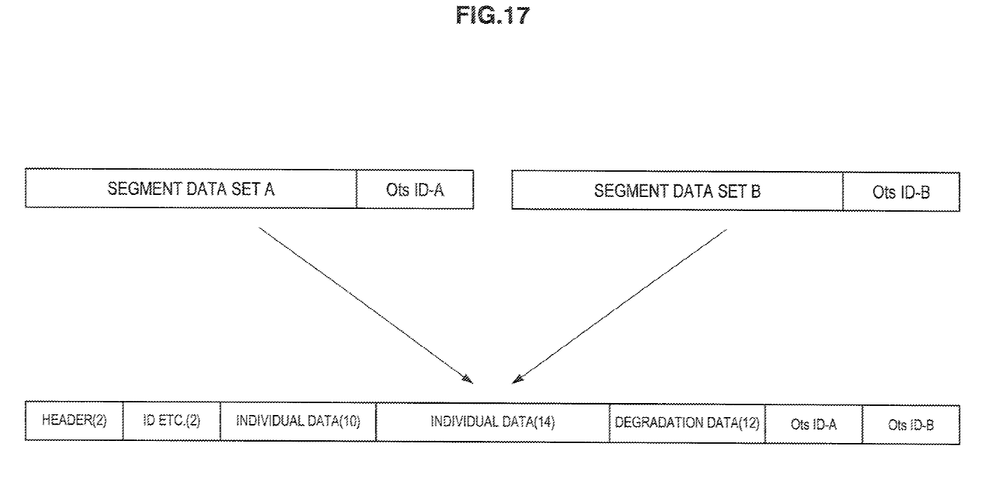

The POS register 210 in the store system 200 restores settlement data by combining the segment data set A and the segment data set B acquired from the mobile phone 100 through bar-code scanning. FIG. 17 is an explanatory view showing restoration of the settlement data. At the time of restoring the authentication data, the POS register 210 determines whether or not the contents of Ots IDs are correct as described before.

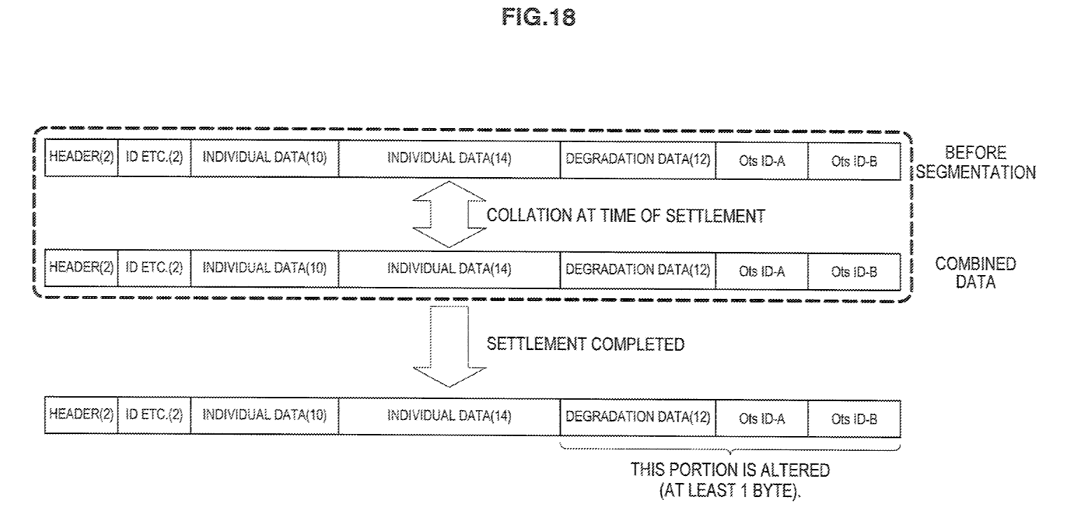

The store system 200 collates the restored settlement data with the settlement data generated by the authentication server 20 at the time of settlement by electronic money with use of the mobile phone 100. FIG. 18 is an explanatory view showing the process of collating the settlement data restored in the store system 200 with the settlement data generated in the authentication server 20. If the settlement data restored in the store system 200 matches with the settlement data generated in the authentication server 20 as a result of collation of both the data sets, the store system 200 requests the settlement server 10 to execute settlement processing by electronic money with use of the mobile phone 100. Although the settlement processing by electronic money which is started on condition that all the data streams in the settlement data sets are matched as a result of collation in the present disclosure has been illustrated, the present disclosure is not limited to the example disclosed. For example, the settlement processing by electronic money may be started on condition that the generated data is collated and matched with part of the settlement data restored in the store system 200.

Once the settlement processing is completed, the authentication server 20 and the store system 200 degrade authentication data. The authentication server 20 and the store system 200 degrade a data portion including the degradation data section, the Ots ID-A, and the Ots ID-B as shown in FIG. 18. The authentication server 20 and the store system 200 do not degrade the settlement data section. This is because the data of the settlement data section may be necessary when settlement is cancelled for some reason, such as for return of a commodity.

In the present embodiment, the authentication server 20 and the store system 200 alter at least a 1-byte portion in each of the degradation data section, the Ots ID-A, and the Ots ID-B, so as to degrade a data portion including the degradation data section, the Ots ID-A, and the Ots ID-B. Of course, in order to achieve more enhanced security, the authentication server 20 and the store system 200 may alter the entire data portion including the degradation data section, the Ots ID-A, and the Ots ID-B.

The authentication server 20 and the store system 200 may write specific data at a portion where data is altered at the time of data degradation. The authentication server 20 and the store system 200 may use, for example, 0, Null, a random value, a hash value, a approximate value, and the like as the specific data, and may also use a combination of these values.

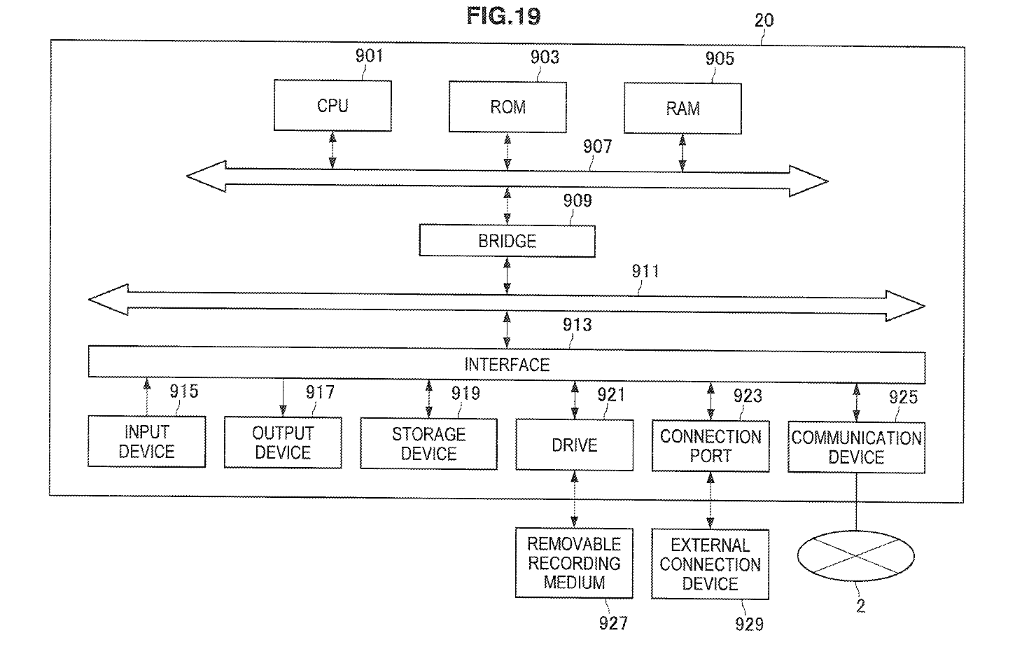

Now, with reference to FIG. 19, a hardware configuration of the authentication server 20 according to one embodiment of the present disclosure will be described in detail. FIG. 19 is a block diagram for explaining the hardware configuration of the authentication server 20 according to one embodiment of the present disclosure.

The authentication server 20 mainly includes a CPU 901, a ROM 903 and a RAM 905. In addition, the authentication server 20 includes a host bus 907, a bridge 909, an external bus 911, an interface 913, an input device 915, an output device 917, a storage device 919, a drive 921, a connection port 923, and a communication device 925.

The CPU 901 serves as an operation processor and a controller, and controls all or some operations in the authentication server 20 in accordance with various programs recorded in the ROM 903, the RAM 905, the storage device 919 or a removable recording medium 927. The ROM 903 stores programs, operation parameters, or the like which are used by the CPU 901. The RAM 905 primarily stores programs which are used by the CPU 901 and parameters which are appropriately modified in the execution of the programs, or the like. These component members are mutually connected via the host bus 907 made of an internal bus such as a CPU bus.

The host bus 907 is connected to the external bus 911 such as a PCI (Peripheral Component Interconnect/Interface) bus via the bridge 909.

The input device 915 may be an operation device which is operated by a user, such as a mouse, a keyboard, a touch panel, buttons, switches and a lever. The input device 915 may be, for example, a remote control unit (a so-called remote control) using infrared light or other radio waves, or may be an external connection device 929 such as a mobile phone and a PDA operable in response to the operation of the authentication server 20. Further, the input device 915 includes, for example, an input control circuit which generates an input signal based on information inputted by a user with use of the above-stated operation device and which outputs the input signal to the CPU 901. By operating the input device 915, the user of the authentication server 20 can input various kinds of data into the authentication server 20, and can instruct processing operation.

The output device 917 includes a device capable of visually or audibly notifying the user of acquired information. Examples of such a device include: a display device such as a CRT display device, an LCD device, a plasma display device, an EL display device, and a lamp; a speech output device such as a speaker and a headphone set; a printer; a mobile phone; and a facsimile. The output device 917 outputs, for example, a result obtained by various processings executed by the authentication server 20. More specifically, the display device displays a result obtained by various processings executed by the authentication server 20 in the form of a text or an image. The speech output device converts an audio signal made of reproduced voice data, sound data, or the like into an analog signal, and outputs the analog signal.

The storage device 919 is a device for data storage which is configured as an example of a storage section of the authentication server 20. The storage device 919 includes, for example, a magnetic storage device such as a HDD (hard disk drive), a semiconductor storage device, an optical storage device, or a magneto-optical storage device. The storage device 919 stores programs and various data to be executed by the CPU 901, various data obtained from the outside, and the like.

The drive 921 is a reader writer for recording media, which is incorporated in or externally attached to the authentication server 20. The drive 921 reads information recorded on the attached removable recording medium 927, such as a magnetic disc, an optical disc, a magneto-optical disc, and a semiconductor memory device, and outputs the read information to the RAM 905. The drive 921 can also write data in the attached removable recording medium 927, such as a magnetic disc, an optical disc, a magneto-optical disc, and a semiconductor memory device. The removable recording medium 927 includes, for example, DVD media, HD-DVD media, Blu-ray media, and the like. The removable recording medium 927 may be a compact flash (registered trademark) (CompactFlash, CF), a flash memory, an SD memory card (secure digital memory card), or the like. The removable recording medium 927 may also be, for example, an IC card (integrated circuit card) or an electronic device that incorporates a noncontact IC chip, and the like.

The connection port 923 is a port used to directly connect devices to the authentication server 20. One example of the connection port 923 includes a USB (universal serial bus) port, an IEEE1394 port, and an SCSI (small computer system interface) port. Another example of the connection port 923 may include an RS-232C port, an optical audio terminal, and an HDMI (high-definition multimedia interface) port. By connecting the external connection device 929 to the connection port 923, the authentication server 20 directly acquires various kinds of data from the external connection device 929, or provides the external connection device 929 with various kinds of data.

The communication device 925 is, for example, a communication interface including a communication device or the like for connection to the communication network 2. The communication device 925 may be, for example, a communication card for a wired or wireless LAN (local area network), Bluetooth (registered trademark), or WUSB (wireless USB), and the like. In addition, the communication device 925 may be a router for optical communication, a router for ADSL (asymmetric digital subscriber line), a modem for various kinds of communications, or the like. The communication device 925 can transmit and receive signals and the like to and from, for example, the Internet or other communication devices based on a predetermined protocol such as TCP/IP. In addition, the communication network 2 connected to the communication device 925 may be made of a network connected in a wired or wireless manner or the like, and may be, for example, the Internet, a home LAN, infrared communication, radio wave communication, satellite communication, or the like.

In the foregoing, one example of the hardware configuration which can implement the function of the authentication server 20 according to the embodiment of the present disclosure has been shown. Each of the above-stated component members may be configured with use of general-purpose components, and may be configured by hardware having a specialized function of each component member. Therefore, it is possible to suitably modify the hardware configuration to be used in accordance with the skill level at the time of implementation of the present embodiment.

### 2. Conclusion

The information processing system 1 according to one embodiment of the present disclosure passes imperfect data sets respectively to the mobile phone 100 and to the store system 200, and combines these data sets to restore complete data. In the information processing system 1 according to one embodiment of the present disclosure, complete data is restored through such segmentation and combining of data sets. Accordingly, since one data set does not make any sense, it becomes possible to use readable information (such as a bar code) as the data which is provided from the mobile phone 100 to the store system 200.

In the information processing system 1 according to one embodiment of the present disclosure, degradation data is used in addition to data such as an electronic money ID and user information, at the time of restoring the authentication data. For example, even if a bar code is reproduced by photographing with a camera or the like, using the degradation data in the information processing system 1 causes mismatch of data sets at the time of the data combining. Accordingly, it may become difficult to reuse the same data.

Since the degradation data is used in the information processing system 1 according to one embodiment of the present disclosure, the authentication data can be used as the data that is valid only for a fixed time period. This enables a user of the mobile phone 100 to make settlement preparation prior to payment of a commodity bill in the POS register 210. Since the degradation data is automatically altered after settlement of the commodity bill, mismatch of data sets typically occurs if the data that has been used once is reused. This makes it possible to prevent reuse of the same settlement data.

In the information processing system 1 according to one embodiment of the present disclosure, a value in the signature key data section of the segment data set, which is transmitted toward the mobile phone 100, is Null. Therefore, settlement data may not be prepared unless proper application exists in the mobile phone 100.

Furthermore, in the information processing system 1 according to one embodiment of the present disclosure, even if the content of a bar code for use in providing data from the mobile phone 100 to the store system 200 is supposedly analyzed, the analyzed data stream is a data stream valid only for a fixed time period, and therefore the content acquired from the analysis result does not have a lasting significance. Even if the bar code is supposedly photographed with a camera or the like, a segment data set which includes degradation data is also transmitted to the store system 200. Accordingly, even if the same bar code is used again, the segment data sets may not be coupled in the store system 200 after settlement.

Even if analysis of the segment data set transmitted to the mobile phone 100 is attempted, data enciphered with a secret key is stored in the signature key data section. Accordingly, unless the secret key is leaked, complete analysis of the segment data set transmitted to the mobile phone 100 may not be performed. The mobile phone 100 can constantly confirm that the mobile phone 100 is a proper client by communicating with the authentication server 20 and periodically updating a key value of the signature key data section.

It is to be noted that in the embodiment disclosed, the mobile phone 100 has been described as an apparatus which does not have the function to perform proximity non-contact communication. However, it should naturally be understood that the mobile phone which has the function to perform proximity non-contact communication can also execute the aforementioned settlement processing without the use of the proximity non-contact communication.

Although in the foregoing embodiment, it has been described that the store system 200 is configured to include the POS register 210 and the store management server 220, the present disclosure is not limited to the example disclosed. For example, the function of the store management server 220 may be incorporated in the POS register 210, so that the store system 200 may include only the POS register 210.

It should be understood by those skilled in the art that various modifications, combinations, sub-combinations and alterations may occur depending on design requirements and other factors insofar as they are within the scope of the appended claims or the equivalents thereof.

For example, the authentication server 20 generates the Ots IDs by shifting the segmented data in the above embodiment, though the present disclosure is not limited to the example disclosed. For example, the authentication server 20 may generate Ots IDs from specific bytes in the segmented data. To be more concrete, when the Ots ID includes 6 bytes, the authentication server 20 uses 1st byte, 3rd byte, 5th byte, 7th byte, 9th byte, and 11th byte of the first half of the segmented data as an Ots ID-A, while using 2nd byte, 4th byte, 6th byte, 8th byte, 10th byte, and 12th byte of the latter half of the segmented data as an Ots ID-B.

For example, in the foregoing embodiment, the mobile phone 100 communicates with the authentication server 20 to periodically update a key value of the signature key data section. However, the present disclosure is not limited to the example disclosed. For example, the key value of the signature key data section may automatically be generated from the content of the user input data section or the binary input data section. For example, the mobile phone 100 may use the content of the user input data section as a key value of the signature key data section in a certain time period, and may use the content of the binary input data section as a key value of the signature key data section in another time period.

For example, it may not be necessary to chronologically execute respective steps in the processing, which is executed by each apparatus of this specification, in the order described in the sequence diagrams or the flow charts. For example, the respective steps in the processing which is executed by each apparatus may be processed in the order different from the order described in the flow charts, and may also be processed in parallel.

Furthermore, it becomes possible to generate a computer program which makes a hardware device, such as a CPU, a ROM, and a RAM incorporated in each apparatus demonstrate the functions equivalent to the configurations of the above described apparatuses. It becomes also possible to provide a storage medium which stores the computer program. In addition, respective functional blocks shown in the functional block diagrams may be constituted from hardware devices, so that a series of processings may be implemented by the hardware devices.

Additionally, the present technology may also be configured as below.

(1) An information processing apparatus, including:

a data generation section generating a specified data stream, and also generating a plurality of segment data sets by segmenting the generated specified data stream and by adding authentication data to each of the segmented data streams; and

a data transmission section transmitting the plurality of segment data sets generated by the data generation section to respective apparatuses.

(2) The information processing apparatus according to (1),

wherein the data generation section generates the authentication data by using at least a part of the segmented data streams.

(3) The information processing apparatus according to (2),

wherein the data generation section generates the authentication data by using data at a specific location in the segmented data streams.

(4) The information processing apparatus according to (3),

wherein the data generation section generates the authentication data by using data of a specific length from a tail of the segmented data streams.

(5) The information processing apparatus according to any one of (1) to (4),

wherein the authentication data is data referred to in settlement processing in the apparatuses.

(6) The information processing apparatus according to any one of (1) to (5),

wherein the data generation section generates the plurality of segment data sets, and also generates, as source data, data in which all pieces of the authentication data are coupled to the specified data stream.

(7) The information processing apparatus according to any one of (1) to (6),

wherein the data generation section includes, in the specified data stream, degradation data whose content is altered after specified processing executed in a destination of the segment data set transmitted by the data transmission section.

(8) The information processing apparatus according to any one of (1) to (7),

wherein the specified data stream includes
an input data section storing data generated from information inputted by a user, and
a signature key data section storing a signature key.

(9) The information processing apparatus according to (8),

wherein the data generation section generates the signature key stored in the signature key data section by using information inputted by a user.

(10) A terminal device, including:

a data acquisition section acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and

a data coupling section coupling the first data with the second data on condition that validity of the first authentication data and the second authentication data has been confirmed.

(11) The terminal device according to (10),

wherein the data coupling section confirms the validity of the first authentication data by collating the first authentication data with a content of the first data excluding a portion of the first authentication data, and confirms the validity of the second authentication data by collating the second authentication data with a content of the second data excluding a portion of the second authentication data.

(12) The terminal device according to (10) or (11), further including

a settlement section executing specified settlement processing when settlement data transmitted in advance from the first apparatus matches with settlement data included in coupled data generated by the data coupling section coupling the first data with the second data.

(13) The terminal device according to (12),

wherein the settlement processing section alters, after the execution of the specified settlement processing, at least any one of degradation data included in the first data, degradation data included in the second data, the first authentication data, and the second authentication data.

(14) An information processing system, including:

a terminal device; and

a mobile terminal,

wherein the mobile terminal includes
a data acquisition section acquiring second data which has been generated in a server apparatus and to which second authentication data has been added, and

wherein the terminal device includes
a data acquisition section acquiring first data which has been generated in the server apparatus and to which first authentication data has been added, and also acquiring second data which has been generated in the server apparatus, which has been transmitted from the server apparatus to the mobile terminal, and to which second authentication data has been added, from the mobile terminal, and
a data coupling section coupling the first data with the second data on condition that validity of the first authentication data and the second authentication data has been confirmed.

(15) A method for information processing, including:

generating a specified data stream, and also generating a plurality of segment data sets by segmenting the generated specified data stream and by adding authentication data to each of the segmented data streams; and

transmitting the plurality of segment data sets generated in the data generating step to respective apparatuses.

(16) A method for information processing, including:

acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and

coupling the first data with the second data on condition that validity of the first authentication data and the second authentication data has been confirmed.

(17) A storage medium storing a computer program for making a computer execute:

generating a specified data stream, and also generating a plurality of segment data sets by segmenting the generated specified data stream and by adding authentication data to each of the segmented data streams; and

transmitting the plurality of segment data sets generated in the data generating step to respective apparatuses.

(18) A storage medium storing a computer program for making a computer execute:

acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and

coupling the first data with the second data on condition that validity of the first authentication data and the second authentication data has been confirmed.

The present disclosure contains subject matter related to that disclosed in Japanese Priority Patent Application JP 2012-149166 filed in the Japan Patent Office on Jul. 3, 2012, the entire content of which is hereby incorporated by reference.

What is claimed is:

1. An information processing apparatus, comprising:
a data generation section generating a specified data stream, and also generating a plurality of segment data sets by segmenting the generated specified data stream and by adding authentication data to each of the segmented data streams; and
a data transmission section transmitting the plurality of segment data sets generated by the data generation section to respective apparatuses.

2. The information processing apparatus according to claim 1,
wherein the data generation section generates the authentication data by using at least a part of the segmented data streams.

3. The information processing apparatus according to claim 2,
wherein the data generation section generates the authentication data by using data at a specific location in the segmented data streams.

4. The information processing apparatus according to claim 3,
wherein the data generation section generates the authentication data by using data of a specific length from a tail of the segmented data streams.

5. The information processing apparatus according to claim 1,
wherein the authentication data is data referred to in settlement processing in the apparatuses.

6. The information processing apparatus according to claim 1,
wherein the data generation section generates the plurality of segment data sets, and also generates, as source data, data in which all pieces of the authentication data are coupled to the specified data stream.

7. The information processing apparatus according to claim 1,
wherein the data generation section includes, in the specified data stream, degradation data whose content is altered after specified processing executed in a destination of the segment data set transmitted by the data transmission section.

8. The information processing apparatus according to claim 1,
wherein the specified data stream includes
an input data section storing data generated from information inputted by a user, and
a signature key data section storing a signature key.

9. The information processing apparatus according to claim 8,
wherein the data generation section generates the signature key stored in the signature key data section by using information inputted by a user.

10. A terminal device, comprising:
a data acquisition section acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and
a data coupling section coupling the first data with the second data on condition that validity of the first authentication data and the second authentication data has been confirmed.

11. The terminal device according to claim 10,
wherein the data coupling section confirms the validity of the first authentication data by collating the first authentication data with a content of the first data excluding a portion of the first authentication data, and confirms the validity of the second authentication data by collating the second authentication data with a content of the second data excluding a portion of the second authentication data.

12. The terminal device according to claim 10, further comprising
a settlement section executing specified settlement processing when settlement data transmitted in advance from the first apparatus matches with settlement data included in coupled data generated by the data coupling section coupling the first data with the second data.

13. The terminal device according to claim 12,
wherein the settlement processing section alters, after the execution of the specified settlement processing, at least any one of degradation data included in the first data, degradation data included in the second data, the first authentication data, and the second authentication data.

14. An information processing system, comprising:
a terminal device; and
a mobile terminal,
wherein the mobile terminal includes
a data acquisition section acquiring second data which has been generated in a server apparatus and to which second authentication data has been added, and
wherein the terminal device includes
a data acquisition section acquiring first data which has been generated in the server apparatus and to which first authentication data has been added, and also acquiring second data which has been generated in the server apparatus, which has been transmitted from the server apparatus to the mobile terminal, and to which second authentication data has been added, from the mobile terminal, and
a data coupling section coupling the first data with the second data on condition that validity of the first authentication data and the second authentication data has been confirmed.

15. A method for information processing, comprising:
generating a specified data stream, and also generating a plurality of segment data sets by segmenting the generated specified data stream and by adding authentication data to each of the segmented data streams; and
transmitting the plurality of segment data sets generated in the data generating step to respective apparatuses.

16. A method for information processing, comprising:
acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and
coupling the first data with the second data on condition that validity of the first authentication data and the second authentication data has been confirmed.

17. A storage medium storing a computer program for making a computer execute:
generating a specified data stream, and also generating a plurality of segment data sets by segmenting the generated specified data stream and by adding authentication data to each of the segmented data streams; and
transmitting the plurality of segment data sets generated in the data generating step to respective apparatuses.

18. A storage medium storing a computer program for making a computer execute:
acquiring first data which has been generated in a first apparatus and to which first authentication data has been added, and also acquiring second data which has been generated in the first apparatus, which has been transmitted from the first apparatus to a second apparatus, and to which second authentication data has been added, from the second apparatus; and
coupling the first data with the second data on condition that validity of the first authentication data and the second authentication data has been confirmed.
